(19) United States
(12) Patent Application Publication
(10) Pub. No.: US 2004/0137196 A1
(43) Pub. Date: Jul. 15, 2004

(54) Environmental protection water-proof safety honeycomb stacking cardboard

(76) Inventor: Shang Jui Wang, Chung-Hua Hsien (TW)

Correspondence Address: Shang Jui Wang, 235 Chung - Ho, Box 8-24, Taipei, TW

(21) Appl. No.: 10/672,203

(22) Filed: Sep. 24, 2003

Related U.S. Application Data
(63) Continuation-in-part of application No. 09/733,341, filed on Dec. 7, 2000, now abandoned.

(51) Int. Cl. B32B 3/12

(52) U.S. Cl. 428/119; 428/116

(57) ABSTRACT

An environmental protection water-proof safety honeycomb stacking cardboard is proposed. The honeycomb stacking cardboard is formed by a flat plate and a plurality of legs below the flat plate. The flat plate, upper leg and lower leg are made by a plurality of honeycomb plates. Top plates processed by water-proof procedure and gluing procedure are adhered on upper sides of the flat plate and lower legs; and bottom plates processed by water-proof procedure and gluing procedure and being adhered on lower sides of the flat plate and legs. Each leg is a long post and includes an upper leg and a lower leg. A periphery of the flat plate are covered by a water-proof kraft paper edge protecting cover with each side having an L shape. The exposed outside of each leg is enclosed by a water-proof kraft paper protecting envelope.

The present invention is a continuation in part (CIP) of U.S. patent Ser. No. 09/733,341, and thus the contents of USP 09/733,341 is incorporated into the present invention as a part of the present invention.

### FIELD OF THE INVENTION

The present invention relates to stacking cardboards, and particularly to an environmental protection water-proof safety honeycomb stacking cardboard,

### BACKGROUND OF THE INVENTION

Stacking cardboards are used to replace the stacking wood boards due to environment and cost consideration. Moreover, the staking cardboards can suffer objects of even 3 tons of each meter square and the weight of stacking cardboard is only one third of that of wood cardboard. The stacking cardboard can be reused and is light so as to reduce the burden of lifting machines.

Currently, corrugated stacking cardboards and honeycomb stacking cardboards are used. Although these two kinds of stacking cardboards have some advantages, they are insufficient in water and pressure-proof.

Referring to FIG. 1A, a stacking cardboard is made of honeycomb cardboard 2 and reused papers 3 and 4 adhered on the top and bottom of the cardboard 2. The bottom is formed with a plurality of transversal and longitudinal slots and then is adhered with a layer of resued paper 40. The disadvantages of this prior art is that:

1. The edges of the stacking cardboards have weak structures (since indication by the arrow in FIG. 1B). when the cardboards are collided by external forces. The edge has a worse tolerance so as to be damaged easily.

2. The grooves at the lower side of the honeycomb stacking cardboard 2 have insufficient strength. Moreover, the honeycomb stacking cardboard 2 are formed with legs so as to have a worse pressure-tolerance ability.

3. When reused paper 40 is adhered to a bottom of the honeycomb stacking cardboard 2, since the legs 2 are arranged longitudinally and transversally, the operation is difficult. Moreover, mold is necessary to apply pressure thereon so that cost in mold is high.

4. If no reused paper 40 is used, the effects in wet and water-proofs are poor so as that the legs are easy to collapse and deform. Moreover, if heavy burdens are applied thereon, these effects will become apparent.

### SUMMARY OF THE INVENTION

Accordingly, the primary object of the present invention is to provide an environmental protection water-proof safety honeycomb stacking cardboard. The honeycomb stacking cardboard is formed by a flat plate and a plurality of legs below the flat plate. The flat plate, upper leg and lower leg are made by a plurality of honeycomb plates. Top plates processed by water-proof procedure and gluing procedure are adhered on upper sides of the flat plate and lower legs; and bottom plates processed by water-proof procedure and gluing procedure and being adhered on lower sides of the flat plate and legs. Each leg is a long post and includes an upper leg and a lower leg. A periphery of the flat plate are covered by a water-proof kraft paper edge protecting cover with each side having an L shape. The exposed outside of each leg is enclosed by a water-proof kraft paper protecting envelope.

The various objects and advantages of the present invention will be more readily understood from the following detailed description when read in conjunction with the appended drawing.

### BRIEF DESCRIPTION OF THE DRAWINGS

FIG. 1A is a cross sectional view of a, prior art honeycomb stacking cardboard.

FIG. 1B is a schematic view showing the prior art honeycomb stacking cardboard which is collided or wetted.

FIG. 2 is a perspective view of the honeycomb stacking cardboard of the present invention.

FIG. 3 is a cross sectional view of the honeycomb stacking cardboard of FIG. 2.

FIG. 4 is an exploded perspective view of the honeycomb stacking cardboard of FIG. 2.

FIG. 5 is a structure perspective view of another embodiment of the honeycomb stacking cardboard according to the present invention.

FIG. 6 is an exploded perspective view of the honeycomb stacking cardboard of the present invention.

FIG. 7 is a structural perspective view of the honeycomb stacking cardboard in another embodiment of the present invention.

FIG. 8 is an exploded perspective view of the honeycomb stacking cardboard according to the present invention.

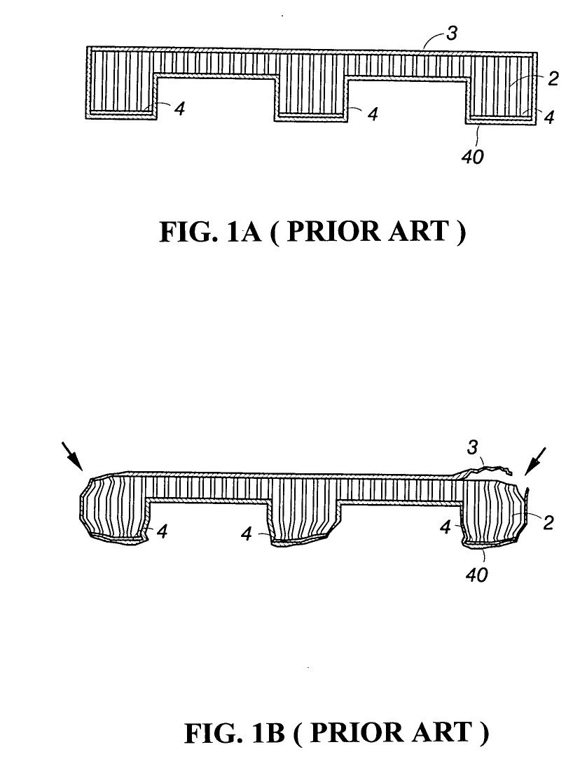

### DETAILED DESCRIPTION OF THE PREFERRED EMBODIMENTS

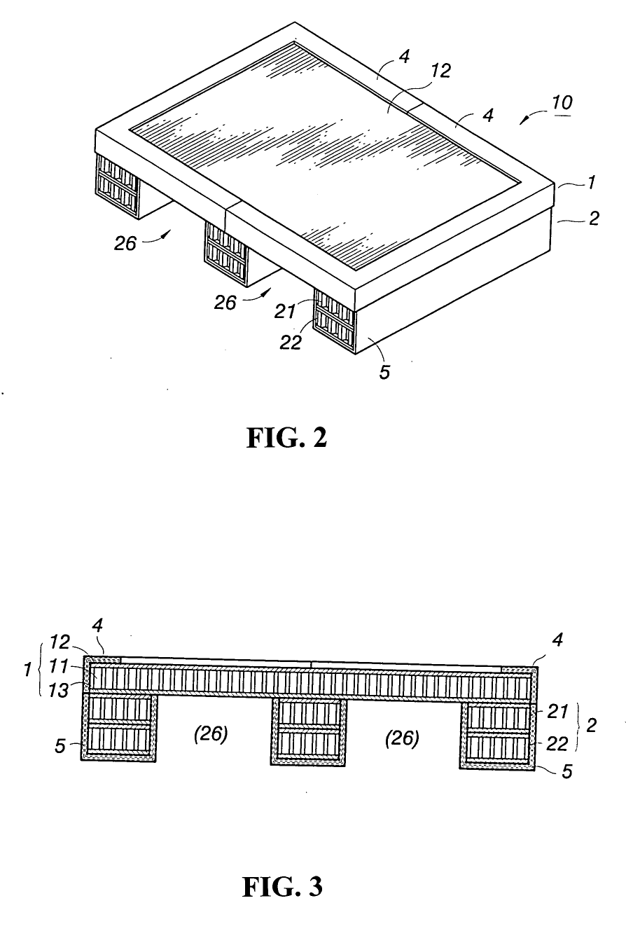

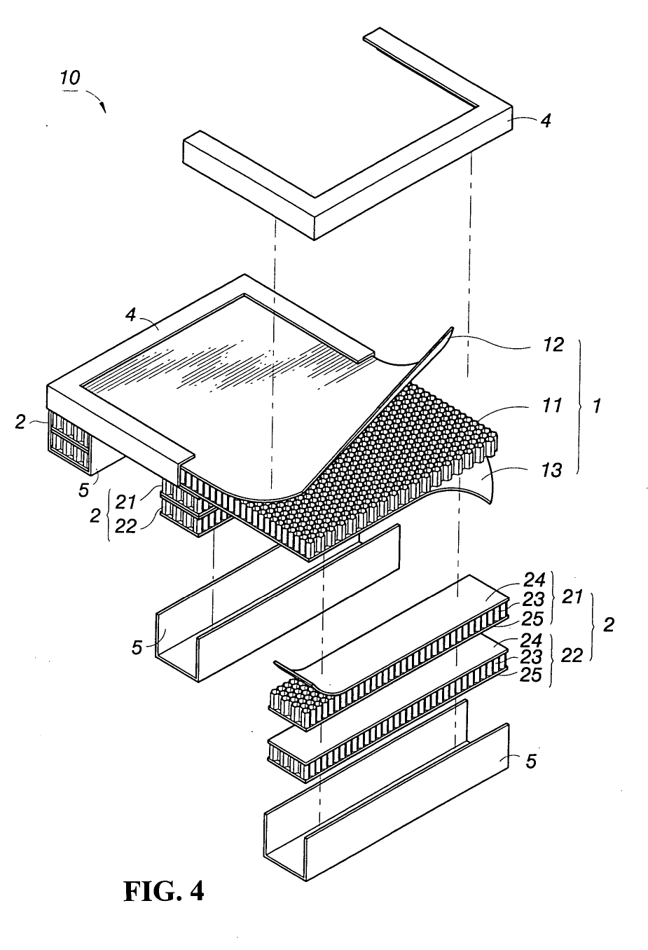

Referring to FIG. 2, the honeycomb stacking cardboard of the present invention is illustrated. The cross sectional view of the honeycomb stacking cardboard of the present invention is illustrated in FIG. 3. The exploded perspective view of the present invention is shown in FIG. 4. In the present invention, the honeycomb stacking cardboard 10 is formed by a flat plate 1 and a plurality of legs 2 below the flat plate 1. Each leg 2 is a long post and includes an upper leg 21 and a lower leg 22. A periphery of the flat plate 1 is covered by a water-proof kraft paper edge protecting cover 4 (each side having an L shape). The exposed outside of each leg 2 is enclosed by a water-proof kraft paper protecting envelope 5. The cover 4 and envelope 5 are made by sticking a plurality of sandpaper of 500 g/m² to a width of 3 mm.

The above said flat plate 1, upper leg 21 and lower leg 22 are made by a plurality of honeycomb plates 11 and 23, paper top plates 12, 24 processed by water-proof procedure and gluing procedure and being adhered to paper bottom plates 13, 25 below the honeycomb plates. The top plates and bottom plates is formed by one kraft paper of 300 g/m², which is a preferred tolerance and anti-tension ability.

The honeycomb plates 11 and 23 can be performed with fire-proof process and then processed by a special honeycomb forming machine and a tension machine. The top and bottom plates are krafts of water-proof or fire-proof and then are adhered to the honeycomb plates by gluing.

Referring to FIG. 3 when the flat plate 1 is combined with the upper leg 21 and lower leg 22 so as to form a combined structure of three layers which has a concrete structure of weight tolerable. The periphery of the flat plate 1 are covered kraft paper protecting cover 4 so that it has a preferred anti-wearing, and anti-collision ability. The kraft paper protecting envelopes 4 enclosing the upper legs 21 and lower legs 2 have the functions of wet-proof, and water-proof.

The lower legs 22 are arranged with an equal distance. A groove is formed between every two legs 2. Thereby, the supporting arms of a lifting machine can lift the honeycomb stacking cardboard 10 from the grooves 26.

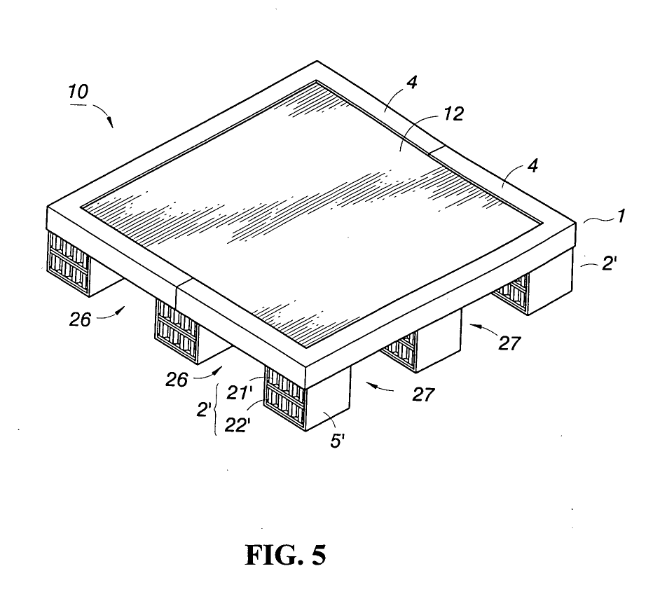

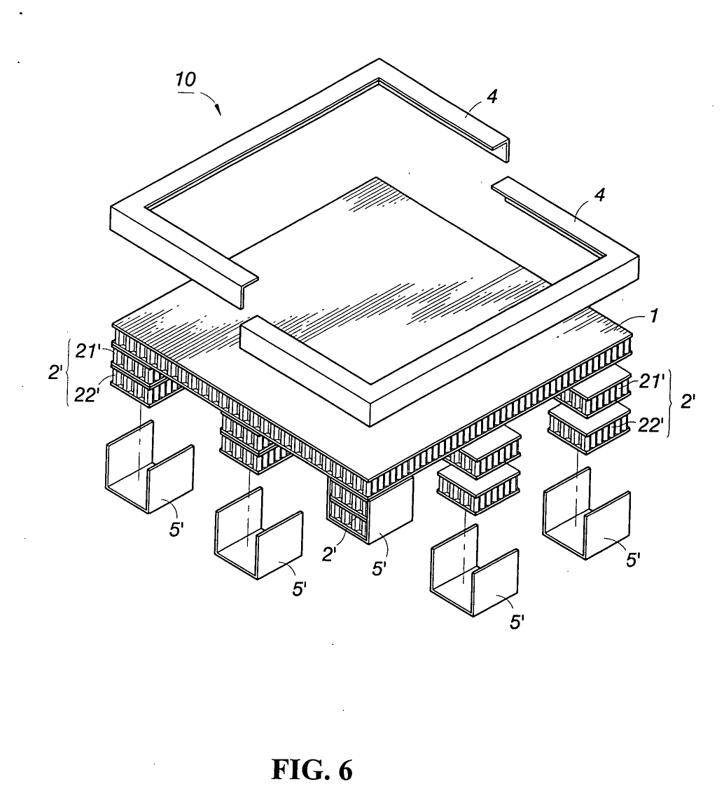

FIG. 5 is another embodiment of the honeycomb stacking cardboard 10 of the present invention. The difference of this embodiment to the former ones is that each leg 2′ has a block form and is formed by a block upper leg 21′ and a block lower leg 22′ and then adhering with a kraft paper protecting envelop 5′. Then the block legs 2 are arranged in parallel so as to formed grooves 26′ and 27′ which longitudinal and transversal arranged. Thereby, supporting arms of a lifting machines can be inserted into the grooves from any sides of the honeycomb stacking cardboard.

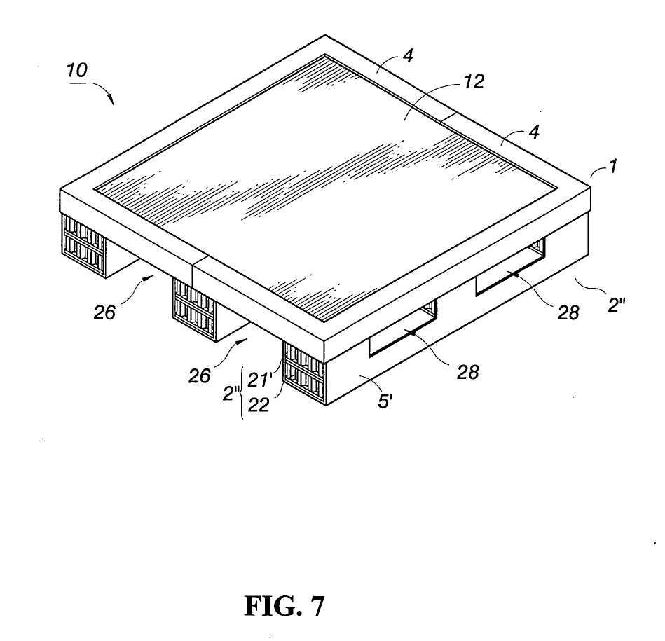

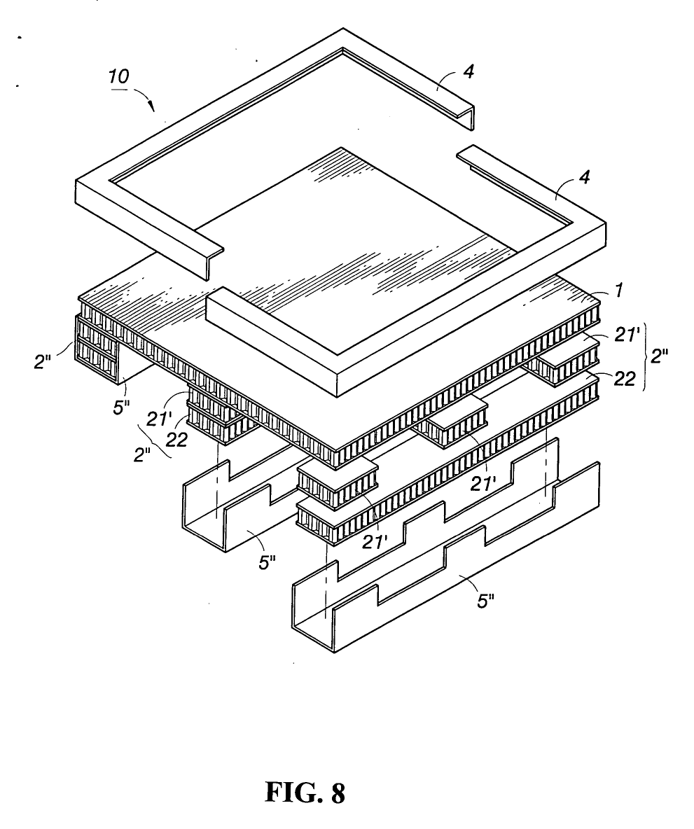

FIG. 7 shows another embodiment of the honeycomb stacking cardboard of the present invention. It is shows that each leg 2″ has at least two transversal slots 28. The way for forming the leg 2″ is illustrated in FIG. 8. Each leg 2″ is formed by three block upper legs 21′, a long lower leg 22 and a kraft paper protecting envelope 5″ so as to formed a leg 2″ with two slots 28. The legs 2 are arranged with an equal distance. Thereby, a plurality of longitudinal grooves 26 and transversal slots 28 are formed so that the supporting arms are inserted into the grooves 28 and slots 26.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An environmental protection water-proof safety honeycomb stacking cardboard; the honeycomb stacking cardboard being formed by a flat plate and a plurality of legs below the flat plate; the flat plate, upper leg and lower leg being made by a plurality of honeycomb plates, top plates processed by water-proof procedure and gluing procedure being adhered on upper sides of the flat plate and lower legs; and bottom plates processed by water-proof procedure and gluing procedure and being adhered on lower sides of the flat plate and legs; characterized in that:
each leg is a long post and includes an upper leg and a lower leg; a periphery of the flat plate is covered by a water-proof kraft paper edge protecting cover with each side having an L shape; the exposed outside of each leg is enclosed by a water-proof kraft paper protecting envelope.

2. The environmental protection water-proof safety honeycomb stacking cardboard as claimed in claim 1, wherein each leg is formed by an upper leg, a lower leg and a kraft paper protecting envelop; the legs are arranged with an equal space in one dimension so as to be formed with a plurality of grooves which are arranged longitudinally.

3. The environmental protection water-proof safety honeycomb stacking cardboard as claimed in claim 1, wherein each leg is formed by an upper leg, a lower leg and a kraft paper protecting envelop; the legs are arranged with an equal space in two dimensions so as to be formed with a plurality of grooves which are arranged longitudinally and transversally.

4. The environmental protection water-proof safety honeycomb stacking cardboard as claimed in claim 1, wherein each leg is formed by three block upper legs, a long lower leg and a kraft paper protecting envelope so as to be formed as a leg with two slots; the legs are arranged with an equal distance; thereby, a plurality of longitudinal grooves and transversal slots are formed
